(19) United States
(12) Patent Application Publication
(10) Pub. No.: US 2009/0156851 A1
(43) Pub. Date: Jun. 18, 2009

(54) Ferrocene-Diphosphine Ligands

(76) Inventors: Walter Weissensteiner, Modling (AT); Yaping Wang, Beijing (CN); Felix Spindler, Starrkirch-Wil (CH); Benoit Pugin, Munchenstein (CH); Xiangdong Feng, Qingdao (CN)

Correspondence Address: WENDEROTH, LIND & PONACK, L.L.P., 1030 15th Street, N.W.,, Suite 400 East, Washington, DC, 20005-1503, US

(21) Appl. No.: 11/990,208

(22) PCT Filed: Aug. 10, 2006
(86) PCT No.: PCT/EP2006/065196

§ 371 Date: Feb. 8, 2008

(30) Foreign Application Priority Data
Aug. 11, 2005 (CH) 01323/05

(51) Int. Cl. C07F 9/02; C07F 15/02

(52) U.S. Cl. 556/22

(57) ABSTRACT

Compounds of the formula (I) in the form of racemates, mixtures of stereoisomers or optically pure stereoisomers, formula (I), where X₁ and X₂ are each, independently of one another, a secondary phosphino group; R₁ is a halogen atom or a—substituent bound via a C atom, N atom, S atom, Si atom, a P(O) group or a P(S) group to the cyclopentadienyl ring; R₂ is C₁-C₄-alkyl or phenyl; m is from 1 to 3 and n is 0 or from 1 to 5, are ligands for complexes of transition metals as enantioselective and homogeneous catalysts. As a result of the substitution, the conversion, the stereoselectivity and/or the configuration of the adduct formed can be influenced and optimization of catalysts can be made possible in this way.

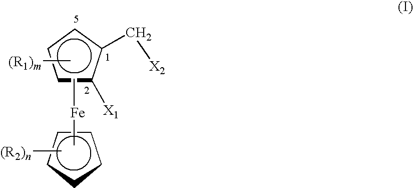

The present invention relates to 1-sec-phosphinomethyl-2-sec-phosphinoferrocenes which are substituted in the cyclopentadienyl ring; processes for preparing them; metal complexes of transition metals with these diphosphines as ligands; and the use of the metal complexes as homogeneous catalysts in asymmetric or symmetric addition reactions and also a process for the preferably asymmetric hydrogenation of prochiral unsaturated organic compounds.

Ferrocene-diphosphines of the formula

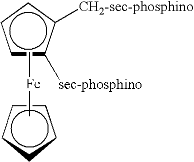

are known. GB 2 289 855 A describes diphosphines of this type, for example [2-(diphenylphosphino)ferrocenyl]methyldicyclohexylphosphine, and Pd complexes thereof for preparing isotactic polymers. WO 01/38336 proposes ligands of this type for metal complexes which serve as asymmetric catalysts for addition reactions, in particular hydrogenations. Depending on the substrate, good conversions and stereoselectivities can be achieved using the catalysts. A disadvantage of these ligands is that only modifications in the phosphino groups is possible in order to optimize reactions. Furthermore, there is a need to increase the activity and/or selectivity of such catalysts further, so that a broader range of possible applications is opened up.

It has now surprisingly been found that both the conversion and/or the stereoselectivity and also the configuration of the adduct formed can be influenced when substituents are introduced into the cyclopentadienyl ring. An increase in the conversion, an increase in the optical yields or both effects or else the formation of desired optical isomers is observed. These substituted ligands are highly suitable for optimization if suitable unsubstituted ligands have been identified for a particular reaction. The ligands can be obtained via a novel preparative process.

The invention provides, firstly, compounds of the formula I in the form of racemates, mixtures of stereoisomers or optically pure stereoisomers,

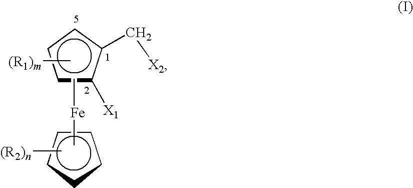

where
X₁ and X₂ are each, independently of one another, a secondary phosphino group;
R₁ is a halogen atom or a substituent bound via a C atom, N atom, S atom, Si atom, a P(O) group or a P(S) group to the cyclopentadienyl ring, with the radicals R₁ in the case of m>1 being identical or different;
R₂ is C₁-C₄-alkyl or phenyl;
m is from 1 to 3 and
n is 0 or from 1 to 5.

For the purposes of illustration, the representational formula of the other enantiomer, which also applies analogously to formulae indicated later, is shown below:

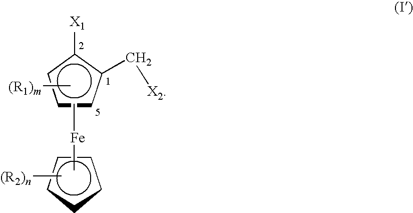

The secondary phosphino groups X₁ and X₂ can contain two identical or two different hydrocarbon radicals. In the latter case, the secondary phosphino groups are P-chiral. The secondary phosphino groups X₁ and X₂ preferably each contain two identical hydrocarbon radicals. Furthermore, the secondary phosphino groups X₁ and X₂ can be identical or different.

The hydrocarbon radicals can be unsubstituted or substituted and/or contain heteroatoms selected from the group consisting of O, S and N. They can contain from 1 to 22, preferably from 1 to 18 and particularly preferably from 1 to 14, carbon atoms. A preferred secondary phosphino group is one which contains two identical or different radicals selected from the group consisting of linear or branched C₁-C₁₂-alkyl; unsubstituted or C₁-C₆-alkyl- or C₁-C₆-alkoxy-substituted C₅-C₁₂-cycloalkyl or C₅-C₁₂-cycloalkyl-CH₂—; phenyl, naphthyl, furyl and benzyl; and phenyl and benzyl substituted by halogen (for example F, Cl and Br), C₁-C₆-alkyl, C₁-C₆-haloalkyl (for example trifluoromethyl), C₁-C₆-alkoxy, C₁-C₆-haloalkoxy (for example trifluoromethoxy), (C₆H₅)₃Si, (C₁-C₁₂-alkyl)₃Si, secondary amino or —CO₂—C₁-C₆-alkyl (for example —CO₂CH₃).

Examples of alkyl substituents on P, which preferably contain from 1 to 6 carbon atoms, are methyl, ethyl, n-propyl, i-propyl, n-butyl, i-butyl, t-butyl and the isomers of pentyl and hexyl. Examples of unsubstituted or alkyl-substituted cycloalkyl substituents on P are cyclopentyl, cyclohexyl, methylcyclopentyl and ethylcyclopentyl, dimethylcyclopentyl, methylcyclohexyl and ethylcyclohexyl and dimethylcyclohexyl. Examples of alkyl-, alkoxy-, haloalkyl-, haloalkoxy- and halogen-substituted phenyl and benzyl substituents on P are o-, m- or p-fluorophenyl, o-, m- or p-chlorophenyl, difluorophenyl or dichlorophenyl, pentafluorophenyl, methylphenyl, dimethylphenyl, trimethylphenyl, ethylphenyl, methylbenzyl, methoxyphenyl, dimethoxyphenyl, trifluoromethylphenyl, bistrifluoromethylphenyl, tristrifluoromethylphenyl, trifluoromethoxyphenyl, bistrifluoromethoxyphenyl and 3,5-dimethyl-4-methoxyphenyl.

Preferred secondary phosphino groups are ones which contain identical radicals selected from the group consisting of C₁-C₆-alkyl, unsubstituted cyclopentyl or cyclohexyl and cyclopentyl or cyclohexyl substituted by from 1 to 3 C₁-C₄-alkyl or C₁-C₄-alkoxy groups, benzyl and in particular phenyl which may each be unsubstituted or substituted by from 1 to 3 C₁-C₄-alkyl, C₁-C₄-alkoxy, F, Cl, C₁-C₄-fluoroalkyl or C₁-C₄-fluoroalkoxy groups. The substituent F can also be present four or five times.

The secondary phosphino groups X₁ and X₂ preferably correspond, independently of one another, to the formula —PR₃R₄, where R₃ and R₄ are each, independently of one another, a hydrocarbon radical having from 1 to 18 carbon atoms which is unsubstituted or substituted by halogen, C₁-C₆-alkyl, C₁-C₆-haloalkyl, C₁-C₆-alkoxy, C₁-C₆-haloalkoxy, (C₁-C₄-alkyl)amino, (C₆H₅)₃Si, (C₁-C₁₂-alkyl)₃Si or —CO₂—C₁-C₆-alkyl and/or contains heteroatoms O.

R₃ and R₄ are preferably identical radicals selected from the group consisting of linear or branched C₁-C₆-alkyl, unsubstituted cyclopentyl or cyclohexyl and cyclopentyl or cyclohexyl substituted by from one to three C₁-C₄-alkyl or C₁-C₄-alkoxy groups, furyl, norbornyl, adamantyl, unsubstituted benzyl and benzyl substituted by from one to three C₁-C₄-alkyl or C₁-C₄-alkoxy groups and in particular unsubstituted phenyl and phenyl substituted by from one to three C₁-C₄-alkyl, C₁-C₄-alkoxy, —NH₂, —N(C₁-C₆-alkyl)₂, OH, F, Cl, C₁-C₄-fluoroalkyl or C₁-C₄-fluoroalkoxy groups.

R₃ and R₄ are particularly preferably identical radicals selected from the group consisting of C₁-C₆-alkyl, cyclopentyl, cyclohexyl, furyl and unsubstituted phenyl and phenyl substituted by from one to three C₁-C₄-alkyl, C₁-C₄-alkoxy and/or C₁-C₄-fluoroalkyl groups.

The secondary phosphino groups X₁ and X₂ can be cyclic sec-phosphino groups, for example groups of the formulae

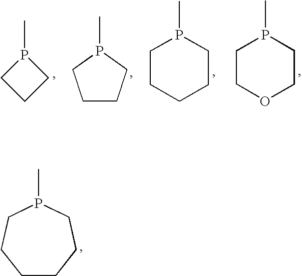

which are unsubstituted or substituted by one or more substituents selected from among —OH, C₁-C₈-alkyl, C₄-C₈-cycloalkyl, C₁-C₆-alkoxy, C₁-C₄-alkoxy-C₁-C₄-alkyl, phenyl, C₁-C₄-alkylphenyl, C₁-C₄-alkoxyphenyl, benzyl, C₁-C₄-alkylbenzyl, C₁-C₄-alkoxybenzyl, benzyloxy, C₁-C₄-alkylbenzyloxy, C₁-C₄-alkoxybenzyloxy and C₁-C₄-alkylidenedioxyl.

The substituents can be bound in one or both a positions relative to the P atom in order to introduce chiral carbon atoms. The substituents in one or both a positions are preferably C₁-C₄-alkyl or benzyl, for example methyl, ethyl, n- or i-propyl, benzyl or —CH₂—O—C₁-C₄-alkyl or —CH₂—O—C₈-C₁₀-aryl.

Substituents in the β,γ positions can be, for example, C₁-C₄-alkyl, C₁-C₄-alkoxy, benzyloxy or —O—CH₂—O—, —O—CH(C₁-C₄-alkyl)-O—, —O—C(C₁-C₄-alkyl)₂-O— and —O—CH(C₆-C₁₀-aryl)-O—. Some examples are methyl, ethyl, methoxy, ethoxy, —O—CH(phenyl)-O—, —O—CH(methyl)-O— and —O—C(methyl)₂O—.

An aliphatic 5- or 6-membered ring or benzene can be fused onto two adjacent carbon atoms in the radicals of the above formulae.

Other known and suitable secondary phosphino radicals are those of cyclic and chiral phospholanes having seven carbon atoms in the ring, for example those of the formulae

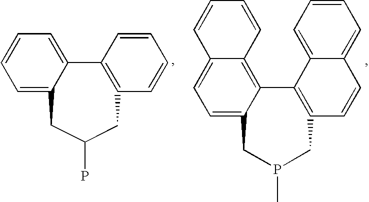

where the aromatic rings may be substituted by C₁-C₄-alkyl, C₁-C₄-alkoxy, C₁-C₄-alkoxy-C₁-C₂-alkyl, phenyl, benzyl, benzyloxy or C₁-C₄-alkylidenedioxyl or C₁-C₄-alkylenedioxyl (see US 2003/0073868 A1 and WO 02/048161).

Depending on the type of substitution and the number of substituents, the cyclic phosphino radicals can be C-chiral, P-chiral or C- and P-chiral.

The cyclic sec-phosphino group can correspond, for example, to the formulae (only one of the possible diastereomers shown),

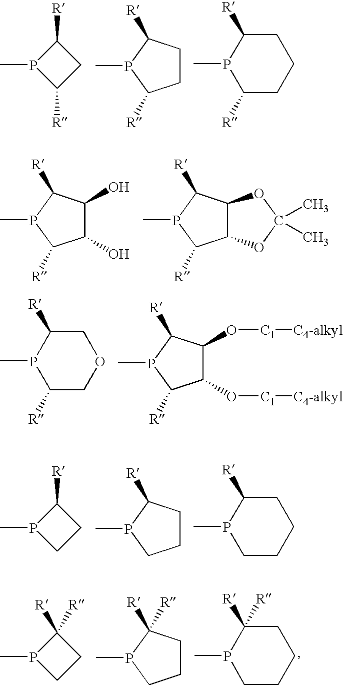

where
the radicals R′ and R″ are each C₁-C₄-alkyl, for example methyl, ethyl, n- or i-propyl, benzyl, or —CH₂—O—C₁-C₄-alkyl or —CH₂—O—C₆-C₁₀-aryl and R′ and R″ are identical or different. When R′ and R″ are bound to the same carbon atom, they can also together be C₄-C₅-alkylene.

In a preferred embodiment, X₁ and X₂ in the compounds of the formula I are particularly preferably identical or different noncyclic sec-phosphino selected from the group consisting of —P(C₁-C₆-alkyl)₂, —P(C₅-C₈-cycloalkyl)₂, —P(C₇-C₁₂-bicycloalkyl)₂, —P(o-furyl)₂, —P(C₆H₅)₂, —P[2-(C₁-C₆-alkyl)C₆H₄]₂, —P[3-(C₁-C₆-alkyl)C₆H₄]₂, —P[4-(C₁-C₆-alkyl)C₆H₄]₂, —P[2-C₁-C₆-alkoxy)C₆H₄]₂, —P[3-(C₁-C₆-alkoxy)C₆H₄]₂, —P[4-(C₁-C₆-alkoxy)C₆H₄]₂, —P[2-(trifluoromethyl)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis(C₁-C₆-alkyl)₂C₆H₃]₂, —P[3,5-bis(C₁-C₆-alkoxy)₂-C₆H₃]₂, —P[3,4,5-tris(C₁-C₆-alkoxy)₂C₆H₃]₂, and —P[3,5-bis(C₁-C₆-alkyl)₂-4-(C₁-C₆-alkoxy)C₆H₂]₂ or cyclic phosphino selected from the group consisting of

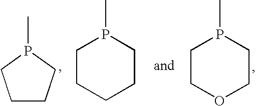

which are unsubstituted or substituted by one or more radicals selected from among C₁-C₄-alkyl, C₁-C₄-alkoxy, C₁-C₄-alkoxy-C₁-C₂-alkyl, phenyl, benzyl, benzyloxy, C₁-C₄-alkylidenedioxyl and unsubstituted or phenyl-substituted methylenedioxyl.

Specific examples are —P(CH₃)₂, —P(i-C₃H₇)₂, —P(n-C₄H₉)₂, —P(i-C₄H₉), —P(C₆H₁₁2, —P(norbornyl)₂, —P(o-furyl)₂, —P(C₆H₅)₂, P[2-(methyl)C₆H₄]₂, P[3-(methyl)C₄H₄]₂, —P[4-(methyl)C₆H₄]₂, —P[2-(methoxy)C₆H₄]₂, —P[3-(methoxy)C₆H₄]₂, —P[4-(methoxy)C₆H₄]₂, —P[3-(trifluoromethyl)C₆H₄]₂, —P[4-(trifluoromethyl)C₄H₄]₂, —P[3,5-bis(trifluoromethyl)C₆H₃]₂, —P[3,5-bis(methyl)C₆H₃]₂, —P[3,5-bis(methoxy)C₆H₃]₂, —P[3,4,5-tri(methoxy)C₆H₂]₂, —P[3,5-bis(methyl)₂-4-(methoxy)C₆H₂]₂ and radicals of the formulae

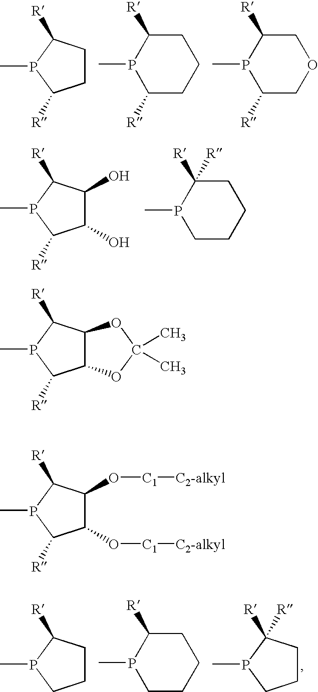

where
R′ is methyl, ethyl, methoxy, ethoxy, phenoxy, benzyloxy, methoxymethyl, ethoxymethyl or benzyloxymethyl and R″ independently has one of the meanings of R′.

In a preferred embodiment of the compounds of the formula I, R₂ is preferably methyl. n in formula I is particularly preferably 0, or in other words, R₂ is then a hydrogen atom.

The substituent R₁ can be present from one to three times, particularly preferably once or twice, in the cyclopentadienyl ring. Preferred positions for a substituent R₁ are the 3, 4 and 5 positions. Preferred substitution patterns are the 3 position, the 5 position and the 3 and 5 positions in the case of double substitution.

In a particularly preferred embodiment of the compounds of the formula I, a substituent is bound in the 5 position and this substituent is a bulky substituent such as branched alkyl, substituted linear or branched alkyl, trimethylsilyl or a substituted or unsubstituted cyclic substituent [(hetero)cycloalkyl or (hetero)aryl)].

The substituents R₁ can be achiral or contain at least one asymmetric carbon atom. An asymmetric carbon atom is preferably located in the α, β or γ position relative to the carbon atom in the cyclopentadienyl ring to which R₁ is bound.

The substituents R₁ can in turn be substituted by one or more substituents, for example from one to three substituents, preferably one or two substituents, for example by halogen (F, Cl or Br, in particular F), —OH, —SH, —CH(O), —CN, —NR₀₁R₀₂, —C(O)—O—R₀₃, —S(O)—O—R₀₃, —S(O)₂—O—R₀₃, —P(OR₀₃)₂, —P(O)(OR₀₃)₂, —C(O)—NR₀₁R₀₂, —S(O)—NR₀₁R₀₂, —S(O)—NR₀₁R₀₂, —O—(O)C—R₀₄, —R₀₁N—(O)C—R₀₄, —R₀₁N—S(O)—R₀₄, —R₀₁N—S(O)₂—R₀₄, C₁-C₄-alkyl, C₁-C₄-alkoxy, C₁-C₄-alkylthio, C₅-C₈-cycloalkyl, phenyl, benzyl, phenoxy or benzyloxy, where R₀₁ and R₀₂ are each, independently of one another, hydrogen, C₁-C₄-alkyl, cyclopentyl, cyclohexyl, phenyl, benzyl or R₀₁ and R₀₂ together form tetramethylene, pentamethylene or 3-oxapentane-1,5-diyl, R₀₃ is hydrogen, C₁-C₈-alkyl, C₅-C₆-cycloalkyl, phenyl or benzyl and R₀₄ is C₁-C₁₈-alkyl, preferably C₁-C₁₂-alkyl, C₁-C₄-haloalkyl, C₁-C₄-hydroxyalkyl, C₅-C₈-cycloalkyl (for example cyclopentyl, cyclohexyl), C₆-C₁₀-aryl (for example phenyl or naphthyl) or C₇-C₁₂-aralkyl (for example benzyl). Two substituents together with the carbon atoms to which they are bound in cyclic substituents also form a saturated or unsaturated, aliphatic or aromatic hydrocarbon ring or heterocyclic ring (fused-on rings and/or bridging rings).

The substituted or unsubstituted substituents R₁ can be, for example, C₁-C₁₂-alkyl, preferably C₁-C₈-alkyl and particularly preferably C₁-C₄-alkyl, C₂-C₁₂-alkenyl, preferably C₂-C₈-alkenyl and particularly preferably C₂-C₄-alkenyl. Examples are methyl, ethyl, n- or i-propyl, n-, i- or t-butyl and the isomers of pentyl, hexyl, heptyl, octyl, decyl and dodecyl and also vinyl and propenyl.

The substituted or unsubstituted substituents R₁ can be, for example, C₃-C₁₂-cycloalkyl, preferably C₅-C₈-cycloalkyl. Examples are cyclopropyl, cyclobutyl, cyclopentyl, cyclohexyl, cycloheptyl, cyclooctyl, cyclodecyl and cyclododecyl.

The substituted or unsubstituted substituents R₁ can be, for example, C₃-C₈-cycloalkyl-C₁-C₄-alkyl, preferably C₅-C₈-cycloalkylalkyl. Examples are cyclopentylmethyl, cyclohexylmethyl or cyclohexylethyl and cyclooctylmethyl.

The substituted or unsubstituted substituents R₁ can be, for example, C₆-C₁₈-aryl and preferably C₆-C₁₀-aryl. Examples are phenyl, naphthyl, anthracenyl and phenanthryl.

The substituted or unsubstituted substituents R₁ can be, for example, C7-C₁₈-aralkyl and preferably C₇-C₁₂-aralkyl, (for example benzyl or 1-phenyleth-2-yl).

The substituted or unsubstituted substituents R₁ can be, for example, tri(C₁-C₄-alkyl)Si or triphenylsilyl. Examples of trialkylsilyl are trimethylsilyl, triethylsilyl-, tri-n-propylsilyl-, tri-n-butylsilyl and dimethyl-t-butylsilyl.

The substituents R₁ can be, for example, halogen. Examples are F, Cl and Br.

The substituted or unsubstituted substituents R₁ can be, for example, a thio radical or a sulphoxide or sulphone radical of the formulae —SR₀₅, —S(O)R₀₅ and —S(O)₂R₀₅, where R₀₅ is C₁-C₁₂-alkyl, preferably C₁-C₈-alkyl and particularly preferably C₁-C₄-alkyl; C₅-C₈-cycloalkyl, preferably C₅-C₈-cycloalkyl; C₆-C₁₈-aryl and preferably C₆-C₁₀-aryl; or C₇-C₁₂-aralkyl. Examples of these hydrocarbon radicals have been mentioned above.

The substituents R₁ can be, for example, —CH(O), —C(O)—C₁-C₄-alkyl or —C(O)—C₆-C₁₀-aryl.

The substituted or unsubstituted substituents R₁ can be, for example, —CO₂R₀₃ or —C(O)—NR₀₁R₀₂ radicals, where R₀₁, R₀₂ and R₀₃ have the meanings given above, including the preferences.

The substituted or unsubstituted substituents R₁ can be, for example, —(O)—O—R₀₃, —S(O)₂—O—R₀₃, —S(O)—NR₀₁R₀₂ and —S(O)₂NR₀₁R₀₂ radicals, where R₀₁, R₀₂ and R₀₃ have the meanings given above, including the preferences.

The substituted or unsubstituted substituents R₁ can be, for example, —P(OR₀₃)₂ or —P(O)(OR₀₃)₂ radicals, where R₀₃ has the meanings given above, including the preferences.

The substituted or unsubstituted substituents R₁ can be, for example, —P(O)(R₀₃) or —P(S)(OR₀₃) radicals, where R₀₃ has the meanings given above, including the preferences.

In a preferred group of substituents R₁, these are selected from among substituted or unsubstituted C₁-C₆-alkyl, substituted or unsubstituted phenyl or naphthyl, tri(C₁-C₄-alkyl)Si, triphenylsilyl, halogen (in particular F, Cl and Br), —SR₀₆, —CH₂OH, —CHR₀₆OH, —CR₀₆R′₀₆OH, —CH₂O—R₀₆, —CH(O), —CO₂H, —CO₂R₀₆, where R₀₆ is a hydrocarbon radical having from 1 to 10 carbon atoms, and —P(O)(R₀₃)₂, where R₀₃ is as defined above.

Examples of substituted or unsubstituted substituents R₁ are methyl, ethyl, n- and i-propyl, n-, i- and t-butyl, pentyl, hexyl, cyclohexyl, cyclohexylmethyl, dicyclohexylmethyl, phenyl, naphthyl, benzyl, naphthylmethyl, diphenylmethyl, trimethylsilyl, F, Cl, Br, methylthio, methylsulphonyl, methylsulphoxyl, phenylthio, phenylsulphonyl, phenylsulphoxyl, —CH(O), —C(O)OH, —C(O)—OCH₃, —C(O)OC₂H₅, —C(O)—NH₂, —C(O)—NHCH₃, —C(O)—N(CH₃), —SO₃H, —S(O)—OCH₃,

—S(O)—OC₂H₅, —S(O)₂—OCH₃, —S(O)—OC₂H₅, —S(O)—NH₂, —S(O)—NHCH₃, —S(O)—N(CH₃)₂, —S(O)—NH₂, —S(O)₂NHCH₃, —S(O)₂—N(CH₃)₂, —P(OH)₂, —PO(OH)₂, —P(OCH₃)₂, —P(OC₂H₅)₂, —PO(OCH₃)₂, —PO(OC₂H₅)₂, trifluoromethyl, methylcyclohexyl, methylcyclohexylmethyl, methylphenyl, dimethylphenyl, methoxyphenyl, dimethoxyphenyl, hydroxymethyl, β-hydroxyethyl, γ-hydroxypropyl, C₆H₅CH(OH), C₆H₅CH(OCH₃), CH₃CH(OH)—, CH₃CH(OCH₃)—, C₂H₅CH(OH)—, C₂H₅CH(OCH₃)—, (CH₃)₂C(OH)—, (CH₃)₂C(OCH₃)—, —CH₂NH₂, —CH₂N(CH₃)₂, —CH₂CH₂NH₂, —CH₂CH₂N(CH₃)₂, methoxymethyl, ethoxymethyl, methoxyethyl, ethoxyethyl, HS—CH₂—, HS—CH₂CH₂, CH₃S—CH₂—, CH₃S—CH₂CH₂—, —CH₂—C(O)OH, —CH₂CH₂—C(O)OH, —CH₂—C(O)OCH₃, —CH₂CH₂—C(O)OCH₃, —CH₂—C(O)NH₂, —CH₂CH₂—C(O)NH₂, —CH₂—C(O)— N(CH₃)₂, —CH₂CH₂—C(O)N(CH₃)₂, —CH₂—SO₃H, —CH₂CH₂—SO₃H, —CH₂—SO₃CH₃, —CH₂CH₂— SO₃CH₃, —CH₂—SO₂NH₂, —CH₂—SO₂N(CH₃), —CH₂—PO₃H₂, —CH₂CH₂—PO₃H₂, —CH₂—PO(OCH₃), —CH₂CH₂—PO(OCH₃)₂, —C₆H₄—C(O)OH, —C₆H₄—C(O)OCH₃, —C₆H₄—S(O)₂OH, —C₆H₄—S(O)₂OCH₃, —CH₂—O—C(O)CH₃, —CH₂CH₂—O—C(O)CH₃, —CH₂—NH—C(O)CH₃, —CH₂CH₂—NH—C(O)CH₃, —CH₂—O—S(O)₂CH₃, —CH₂CH₂—O—S(O)₂CH₃, —CH₂—NH—S(O)₂CH₃, —CH₂CH₂—NH—S(O)₂CH₃, —P(O)(C₁-C₈-alkyl)₂, —P(S)(C₁-C₈-alkyl)₂, —P(O)(C₆-C₁₀-aryl)₂, —P(S)(C₆-C₁₀-aryl)₂, —C(O)—C₁-C₈-alkyl and —C(O)—C₆-C₁₀-aryl.

Preferred compounds of the formula I correspond to racemates, mixtures of stereoisomers or optically pure stereoisomers of the formula Ia

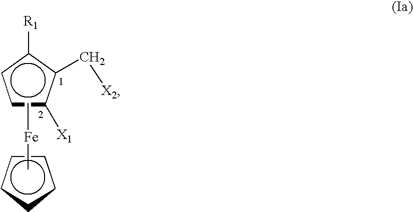

where
X₁ and X₂ are each, independently of one another, a secondary phosphino group;
R₁ is a halogen atom or a substituent bound via a carbon atom or Si atom to the cyclopentadienyl ring.

For the purposes of illustration, the formula Ib of the other enantiomer will be given:

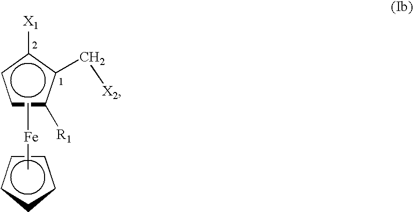

where the representation also applies analogously to later formulae.

In the compounds of the formula Ia, R₁ is preferably substituted or unsubstituted, linear or branched C₁-C₁₂-alkyl, substituted or unsubstituted C₃-C₁₂-cycloalkyl, substituted or unsubstituted C₃-C₈-cyloalkyl-C₁-C₄-alkyl, substituted or unsubstituted C₆-C₁₈-aryl, substituted or unsubstituted C₇-C₁₈-aralkyl, tri(C₁-C₄-alkyl)Si—, triphenylsilyl or F, Cl and Br.

The compounds of the formula I can be prepared by various methods, depending on the position in which substituents are to be introduced. The ortho position relative to the group X₁ in the cyclopentadienyl group (hereinafter referred to as cp for short) is the 3 position. The ortho position relative to the group —CH₂X₂ in the cp group is the 5 position. The 4 position is located between the 3 and 5 positions.

Central precursors are compounds of the formula II which can be selectively metallated in one of the ortho positions and then be modified further,

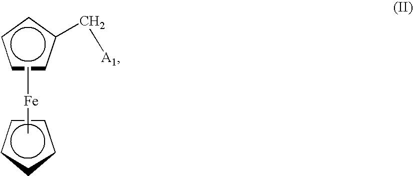

where

A₁ is an open-chain or cyclic, achiral sec-amino or a chiral sec-amino in which at least one carbon atom is substituted by di(C₁-C₄-alkyl)amino or C₁-C₄-alkoxy, preferably in the α, β or γ positions relative to the N atom. Some of the compounds of the formula II are known [see I. Fleischer et al. in Coll. Czech. Chem. Comm., 69(2), (2004), pages 330 to 338 and W. Weissensteiner et al. In J. Org. Chem., 66, (2001), pages 8912 to 8919] or can be prepared by methods analogous to known methods.

An open-chain or cyclic sec-amino group A₁ can correspond to the formula R₅R₆N—, where R₅ and R₆ are each, independently of one another, C₁-C₁₂-alkyl and preferably C₁-C₆-alkyl, C₃-C₈-cycloalkyl and preferably C₅-C₆-cycloalkyl, or together with the N atom form a 3- to 8-membered and preferably 5- to 8-membered N-heterocyclic ring, and at least one of R₅ and R₆ and/or the heterocyclic ring contain an O- or N-containing substituent when A₁ is chiral sec-amino.

Examples of alkyl, which is preferably linear, are methyl, ethyl, propyl, butyl, pentyl, hexyl, heptyl and octyl. Examples of cycloalkyl are cyclopentyl, cyclohexyl and cyclooctyl. Examples of cycloalkyl are in particular cyclopentyl and cyclohexyl. R₅ and R₆ together are preferably tetramethylene, pentamethylene, 3-oxapentylene or 3-(C₁-C₄-alkyl)-N-pentylene when the sec-amino forms an N-heterocylic ring. Suitable substituents are, for example, C₁-C₄-alkoxy, C₁-C₄-alkoxymethyl, C₁-C₄-alkoxyethyl, (C₁-C₄-alkyl)₂N—, (C₁-C₄-alkyl)₂N-methyl and (C₁-C₄-alkyl)₂N-ethyl. The substituents are located, for example, in the γ position and preferably the α or β positions relative to the N atom of the sec-amino group. R₅ and R₆ can additionally be substituted by C₁-C₄-alkyl, C₅-C₆-cycloalkyl, phenyl or benzyl.

In a preferred embodiment, R₅ and R₆ are each methyl, ethyl, cyclohexyl or R₅ and R₆ together are tetramethylene, pentamethylene or 3-oxapentylene, which are each substituted by C₁-C₄-alkoxy, C₁-C₄-alkoxymethyl, C₁-C₄-alkoxyethyl, (C₁-C₄-alkyl)₂N—, (C₁-C₄-alkyl)₂N-methyl and (C₁-C₄-alkyl)₂N-ethyl and, if desired, additionally by C₁-C₄-alkyl, C₅-C₈-cycloalkyl, phenyl or benzyl.

Particularly preferred examples of A₁ are sec-amino radicals of the formulae

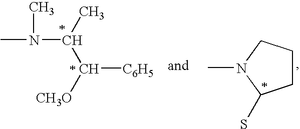

where S is C₁-C₄-alkoxy, C₁-C₄-alkoxymethyl, C₁-C₄-alkoxyethyl, (C₁-C₄-alkyl)₂N—, (C₁-C₄-alkyl)₂N-methyl or (C₁-C₄-alkyl)₂N-ethyl, where the “*”s represent asymmetric centres.

The possible methods of preparation including all substitution patterns for the compounds of the formula I are indicated in the two reaction schemes 1 and 2 below.

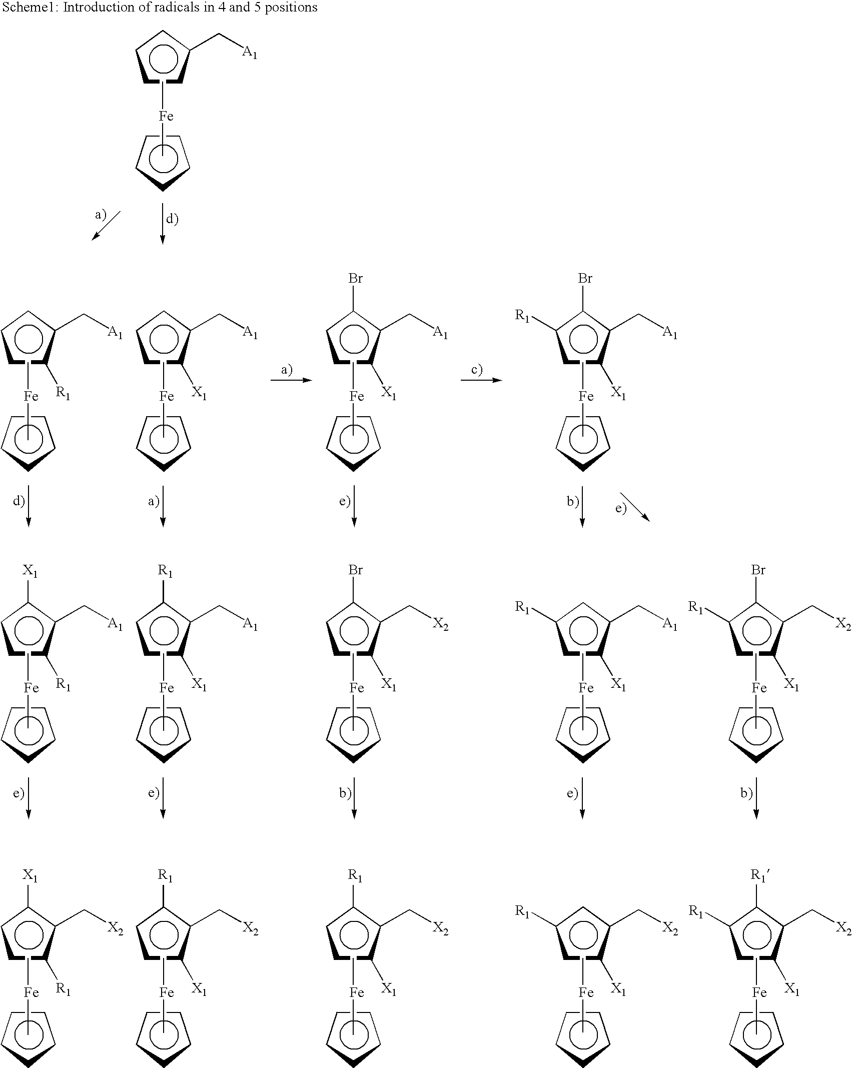

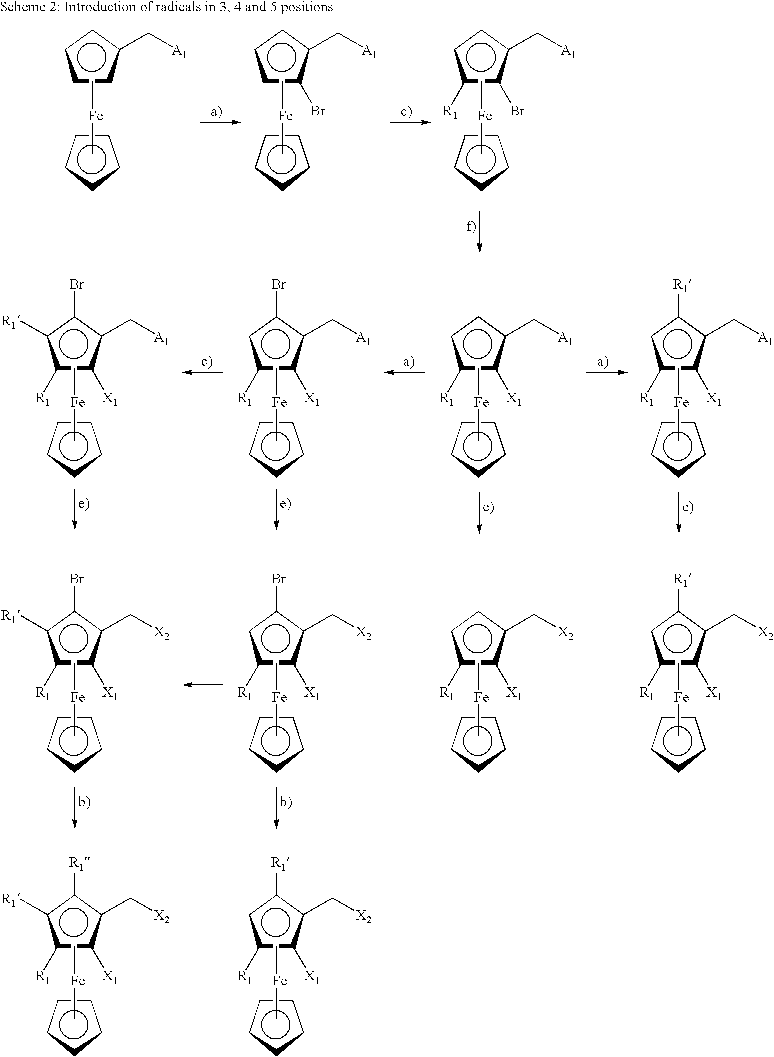

Instead of the bromides, it is also possible to use the iodides.

R₁′ and R₁″ in the above formulae have, independently of one another, the same meanings as R₁.

### Step a): Introduction of Substituents in the Ortho Position Relative to the A₁CH₂— Group

Metallation is firstly carried out by means of a metallating reagent such as alkyllithium and the metallated product is subsequently reacted with an electrophilic compound.

### Step b): Replacement of Br or I by H or a Substituent

After metallation by means of, for example, alkyllithium, the metallated product is reacted either with water (introduction of H) or an electrophilic compound. Catalytic methods of introducing radicals R₁, for example Suzuki coupling and Heck reactions, are also known.

### Step c): Introduction of a Substituent in the Ortho Position Relative to a Halogen (F, Cl, Br)

In a further process step, the ortho position relative to the halogen is selectively lithiated by means of Li amides and the desired substituents are then introduced in a second process step by reaction with appropriate electrophiles.

### Step d): Introduction of X₁ in the Ortho Position Relative to the A₁CH₂— Group

Metallation is firstly carried out by means of metallation reagents such as alkyllithium and the lithiated product is subsequently reacted with a halogen X₁.

### Step e): Replacement of A₁ by X₂

The group A₁ is replaced in a manner known per se using a secondary phosphine (preferably of the formula R₃R₄PH).

### Step f): Replacement of Br or I by X₁

After metallation by means of, for example, alkyllithium, the metallated product is reacted with a halogen X₁.

Depending on the reaction sequence, the substituent introduced has to be inert towards metallation reagents and/or under the reaction conditions in the replacement of A₁ by a secondary phosphino group. Another possibility is the known use of protective groups which can be split off for radicals which are sensitive to reaction conditions selected.

The individual process steps with the exception of step c) are known and are widely described in the literature.

The metallation of ferrocenes involves known reactions which have been described, for example, by W. Weissensteiner et al., J. Org. Chem., 66 (2001) 8912-9, W. Weissensteiner et al., Synthesis 8 (1999), pages 1354-1362, T. Hayashi et al., Bull. Chem. Soc. Jpn. 53 (1980), pages 1138 to 1151 or in Jonathan Clayden Organolithiums: Selectivity for Synthesis (Tetrahedron Organic Chemistry Series), Pergamon Press (2002). The alkyl in the alkyllithium can, for example, contain from 1 to 4 carbon atoms. Use is frequently made of methyllithium and butyllithium. Magnesium Grignard compounds are preferably ones of the formula (C₁-C₄-alkyl)MgX₀, where X₀ is Cl, Br or I.

The reaction is advantageously carried out at low temperatures, for example from 20 to −100° C., preferably from 0 to −80° C. The reaction time is from about 2 to 20 hours. The reaction is advantageously carried out under an inert protective gas, for example nitrogen or noble gases such as argon.

The reaction is advantageously carried out in the presence of inert solvents. Such solvents can be used either alone or as a combination of at least two solvents. Examples of solvents are aliphatic, cycloaliphatic and aromatic hydrocarbons and also open-chain or cyclic ethers. Specific examples are petroleum ether, pentane, hexane, cyclohexane, methylcyclohexane, benzene, toluene, xylene, diethyl ether, dibutyl ether, tert-butyl methyl ether, ethylene glycol dimethyl or diethyl ether, tetrahydrofuran and dioxane.

The introduction of halogens is generally carried out directly after the metallation in the same reaction mixture, with similar reaction conditions as in the metallation being maintained. From 1 to 1.4 equivalents of a halogenated reagent can preferably be used. Halogenated reagents are, for example, halogens (Cl₂, Br₂, I₂), interhalogens (Cl—Br, Cl—I) and aliphatic, perhalogenated hydrocarbons (Cl₃C—CCl₃ or BrF₂C—CF₂Br) for introducing Cl, Br or I; or N-fluorobis(phenyl)sulphonylamine for introducing fluorine.

The metallation in the ortho position relative to the A₁CH₂— group and the introduction of electrophiles proceed regioselectively and the intermediates are obtained in high yields. The reaction is also stereoselective in the presence of a chiral group A₁CH₂—. Furthermore, if necessary at all, it is possible for optical isomers to be separated at this stage, for example by chromatography using chiral columns.

In process stage c), the ferrocene skeleton is once again metallated regioselectively in the ortho position relative to the halogen atom in the same cyclopentadienyl ring, with metal amides being sufficient to replace the acidic H atom in the ortho position relative to the halogen atom. At least from 1 to 5 equivalents of an aliphatic lithium sec-amide or a ClMg, BrMg or IMg sec-amide are used per CH group in the cyclopentadienyl ring of the ferrocene.

Aliphatic lithium sec-amide or halogenMg sec-amide can be derived from secondary amines containing from 2 to 18, preferably from 2 to 12 and particularly preferably from 2 to 10, carbon atoms. The aliphatic radicals bound to the N atom can be alkyl, cycloalkyl or cycloalkylalkyl, or can be N-heterocyclic rings having from 4 to 12, preferably from 5 to 7, carbon atoms. Examples of radicals bound to the N atom are methyl, ethyl, n- and i-propyl, n-butyl, pentyl, hexyl, cyclopentyl, cyclohexyl and cyclohexylmethyl. Examples of N-heterocyclic rings are pyrrolidine, piperidine, morpholine, M-methylpiperazine, 2,2,6,6-tetramethyl-piperidine and azanorbomane. In a preferred embodiment, the amides correspond to the formulae Li—N(C₃-C₄-alkyl)₂ or X₂Mg—N(C₃-C₄-alkyl)₂, where alkyl is, in particular, i-propyl. In another preferred embodiment, the amides correspond to Li(2,2,6,6-tetramethylpiperidine).

Examples of reactive electrophilic compounds for forming radicals R₁ are:

halogens (Cl₂, Br₂, I₂), interhalogens (Cl—Br, Cl—I) and aliphatic, perhalogenated hydrocarbons (Cl₃C—CCl₃ or BrF₂C—CF₂Br, N-fluorobis(phenyl)sulphonylamine) for introducing F, Cl, Br or I; CO₂ for introducing the carboxyl group —CO₂H;
chlorocarbonates or bromocarbonates [Cl—C(O)—OR] for introducing a carboxylate group, where R is a hydrocarbon radical (alkyl, cycloalkyl, cycloalkylalkyl, aryl, aralkyl, heteroaryl, heteroaralkyl) which has from 1 to 18, preferably from 1 to 12 and particularly preferably from 1 to 8, carbon atoms and is unsubstituted or substituted by inert substituents such as sec-phosphino, di(C₁-C₈-alkyl)₂N—, —C(O)—OC₁-C₈-alkyl or —OC₁-C₈-alkyl (inert substituents also include reactive groups such as Cl, Br or I when groups which are more reactive towards a metal or a metal group, for example —CHO, are at the same time present in compounds of the formula I or when Cl and Br, Cl and I or Br and I are simultaneously present in bound form in a preferably aromatic hydrocarbon radical);
di(C₁-C₄-alkyl)formamides, for example dimethylformamide or diethylformamide, for introducing the group —CH(O);
di(C₁-C₄-alkyl)carboxamides for introducing a —C(O)—R group;
aldehydes which may be unsubstituted or substituted by sec-phosphino in the group R for introducing a —CH(OH)—R group or paraformaldehyde for introducing the —CH₂OH group; symmetrical or unsymmetrical ketones which may be unsubstituted or substituted by sec-phosphino in the R or Rₐ group for introducing a —C(OH)RRₐ group, where Rₐ independently has one of the meanings of R or R and Rₐ together form a cycloaliphatic ring having from 3 to 8 ring members;
epoxides for introducing a —C—C—OH group in which the C atoms may be substituted by H or R;
Eschenmoser salt of the formula (CH₃)N⁺═CH₂×I⁻;
imines R—CH═N—Rₐ for introducing the group —CH(R)—NHRₐ, where Rₐ independently has one of the meanings of R or R and Rₐ together form a cycloaliphatic ring having from 3 to 8 ring members; R and Rₐ are not simultaneously hydrogen;
imines R—C(R_{b})═N—Rₐ for introducing the group —C(R)(R_{b})—NHRₐ, where Rₐ independently has one of the meanings of R or R and R′ together form a cycloaliphatic ring having from 3 to 8 ring members, R_{b} independently has one of the meanings of R or R and R_{b} together form a cycloaliphatic ring having from 3 to 8 ring members;
hydrocarbon monohalides and heterohydrocarbon monohalides, in particular chlorides, bromides and iodides, for introducing hydrocarbon and heterohydrocarbon radicals (for example C₁-C₁₈-alkyl, C₆-C₁₄-aryl, C₇-C₁₄-aralkyl);
halohydrocarbons and haloheterohydrocarbons having halogen atoms of differing reactivity, in particular combinations of chlorine with bromine or iodine, bromine with iodine or two bromine or iodine atoms, for introducing hydrocarbon and heterohydrocarbon radicals (for example C₁-C₁₈-alkyl, C₆-C₁₄-aryl, C₇-C₁₄-aralkyl);
arylboronic acids for introducing aryl and heteroaryl radicals;
alkenyl halides, in particular chlorides, bromides and iodides, for introducing alkenyl groups such as allyl and vinyl;
tri(C₁-C₈-alkyl)silyl halides (chlorides, bromides) for introducing the tri(C₁-C₈-alkyl)-Si— group, triphenylsilyl halides for introducing the triphenylsilyl group;
phosphoric ester monohalides (chlorides, bromides) for introducing phosphonic ester groups such as (CH₃O)₂(O)P—, (C₂H₅O)(O)P—, (cyclohexylO)₂(O)P—, (ethylenedioxyl)(O)P—;
phosphoric thioester monohalides (chlorides, bromides) for introducing phosphonic thioester groups such as (CH₃O)₂(S)P—, (C₂H₅O)(S)P—, (cyclohexylO)₂(S)P—, (ethylenedioxyl)(S)P—;
organic disulphides R—SS—R for introducing the —SR group; and
sulphur (S₈) for introducing the —SH group.

Organic radicals in the electrophiles can be substituted as described above.

The metal complexes of the invention are homogeneous catalysts or catalyst precursors which can be activated under the reaction conditions which can be used for asymmetric addition reactions onto prochiral, unsaturated, organic compounds, see E. Jacobsen, A. Pfaltz, H. Yamamoto (Eds.), Comprehensive Asymmetric Catalysis I to III, Springer Verlag, Berlin, 1999, and B. Cornils et al., in Applied Homogeneous Catalysis with Organometallic Compounds, Volume 1, Second Edition, Wiley VCH-Verlag (2002).

The compounds of the formula I according to the invention are ligands for complexes of metals selected from among transition metals in the Periodic Table, preferably the group of TM8 metals, particularly preferably from the group consisting of Ru, Rh and Ir, which are excellent catalysts or catalyst precursors for asymmetric syntheses, for example the asymmetric hydrogenation of prochiral, unsaturated, organic compounds. If prochiral unsaturated organic compounds are used, a very high excess of optical isomers can be induced in the synthesis of organic compounds and a high chemical conversion can be achieved in short reaction times. The achievable enantioselectivites and catalyst activities are excellent and in an asymmetric hydrogenation are considerably higher than in the case of the known unsubstituted ligands mentioned at the outset. Furthermore, such ligands can also be used in other asymmetric addition or cyclization reactions.

The invention further provides complexes of metals selected from among the group of transition metals of the Periodic Table with one of the compounds of the formula I as ligand.

Possible metals are, for example, Cu, Ag, Au, Ni, Co, Rh, Pd, Ir, Ru and Pt. Preferred metals are rhodium and iridium and also ruthenium, platinum, palladium and copper.

Particularly preferred metals are ruthenium, rhodium and iridium.

The metal complexes can, depending on the oxidation number and coordination number of the metal atom, contain further ligands and/or anions. They can also be cationic metal complexes. Such analogous metal complexes and their preparation have been widely described in the literature.

The metal complexes can, for example, correspond to the general formulae III and IV

A₃MeL_{r,} (III)

(A₃MeLᵣ)^{(z+)}(E⁻)_{z,} (IV)

where A₃ is one of the compounds of the formula I,
L represents identical or different monodentate, anionic or nonionic ligands, or L represents identical or different bidentate, anionic or nonionic ligands;
r is 2, 3 or 4 when L is a monodentate ligand or n is 1 or 2 when L is a bidentate ligand;
z is 1, 2 or 3;
Me is a metal selected from the group consisting of Rh, Ir and Ru; with the metal having the oxidation state 0, 1, 2, 3 or 4;
E⁻ is the anion of an oxo acid or complex acid; and
the anionic ligands balance the charge of the oxidation state 1, 2, 3 or 4 of the metal.

The above-described preferences and embodiments apply to the compounds of the formula I.

Monodentate nonionic ligands can, for example, be selected from the group consisting of olefins (for example ethylene, propylene), solvating solvents (nitriles, linear or cyclic ethers, unalkylated or N-alkylated amides and lactams, amines, phosphines, alcohols, carboxylic esters, sulphonic esters), nitrogen monoxide and carbon monoxide.

Suitable polydentate anionic ligands are, for example, allyls (allyl, 2-methallyl), cyclopentadienyl or deprotonated 1,3-diketo compounds such as acetylacetonate.

Monodentate anionic ligands can, for example, be selected from the group consisting of halide (F, Cl, Br, I), pseudohalide (cyanide, cyanate, isocyanate) and anions of carboxylic acids, sulphonic acids and phosphonic acids (carbonate, formate, acetate, propionate, methylsulfonate, trifluoromethylsulphonate, phenylsulfonate, tosylate).

Bidentate nonionic ligands can, for example, be selected from the group consisting of linear or cyclic diolefins (for example hexadiene, cyclooctadiene, norbornadiene), dinitriles (malononitrile), unalkylated or N-alkylated carboxylic diamides, diamines, diphosphines, diols, dicarboxylic diesters and disulphonic diesters.

Bidentate anionic ligands can, for example, be selected from the group consisting of anions of dicarboxylic acids, disulphonic acids and diphosphonic acids (for example of oxalic acid, malonic acid, succinic acid, maleic acid, methylenedisulphonic acid and methylenediphosphonic acid).

Preferred metal complexes also include those in which E is —Cl⁻, —Br⁻, —I⁻, ClO₄⁻, CF₃SO₃⁻, CH₃SO₃⁻, HSO₄⁻, (CF₃SO₂)₂N⁻, (CF₃SO₂)₃C⁻, tetraarylborates such as B(phenyl)₄⁻, B[bis(3,5-trifluoromethyl)phenyl]₄⁻, B[bis(3,5-dimethyl)phenyl]₄⁻, B(C₆F₅)₄⁻ and B(4-methylphenyl)₄⁻, BF₄⁻, PF₆⁻, SbCl₆⁻, AsF₆⁻ or SbF₆⁻.

Particularly preferred metal complexes which are particularly suitable for hydrogenations correspond to the formulae V and VI,

[A₃MeY₁Z], (V)

[A₃MeY₁]⁺E₁^{-,} (VI)

where
A₃ is one of the compounds of the formula I;
Me is rhodium or iridium;
Y₁ is two olefins or a diene;

### Z is Cl, Br or I; and

E₁⁻ is the anion of an oxo acid or complex acid.

The above-described embodiments and preferences apply to the compounds of the formula I.

Olefins Y₁ can be C₂-C₁₂-olefins, preferably C₂-C₆-olefins and particularly preferably C₂-C₄-olefins. Examples are propene, 1-butene and in particular ethylene. The diene can have from 5 to 12, preferably from 5 to 8, carbon atoms and can be an open-chain, cyclic or polycyclic diene. The two olefin groups of the diene are preferably connected by one or two CH₂ groups. Examples are 1,4-pentadiene, cyclopentadiene, 1,5-hexadiene, 1,4-cyclohexadiene, 1,4- or 1,5-heptadiene, 1,4- or 1,5-cycloheptadiene, 1,4- or 1,5-octadiene, 1,4- or 1,5-cyclooctadiene and norbornadiene. Y is preferably two ethylenes or 1,5-hexadiene, 1,5-cyclooctadiene or norbornadiene.

In the formula V, Z is preferably Cl or Br. Examples of E₁ are BF₄⁻, ClO₄⁻, CF₃SO₃⁻, CH₃SO₃⁻, HSO₄⁻, B(phenyl)₄⁻, B[bis(3,5-trifluoromethyl)phenyl]₄⁻, PF₆⁻, SbCl₆⁻, AsF₆⁻ or SbF₆⁻.

The metal complexes of the invention are prepared by methods known in the literature (see also U.S. Pat. No. 5,371,256, U.S. Pat. No. 5,446,844, U.S. Pat. No. 5,583,241 and E. Jacobsen, A. Pfaltz, H. Yamamoto (Eds.), Comprehensive Asymmetric Catalysis I to III, Springer Verlag, Berlin, 1999, and references cited therein).

Ruthenium complexes can, for example, correspond to the formula VII,

[RuₐH_{b}Z_{c}(A₃)_{d}Lₐ]ᵣ(E^{k})_{g}(S)_{h,} (VII)

where
Z is Cl, Br or I; A₃ is a compound of the formula I; L represents identical or different ligands; E⁻ is the anion of an oxo acid, mineral acid or complex acid; S is a solvent capable of coordination as ligand; and a is from 1 to 3, b is from 0 to 4, c is from 0 to 6, d is from 1 to 3, e is from 0 to 4, f is from 1 to 3, g is from 1 to 4, h is from 0 to 6 and k is from 1 to 4, with the total charge on the complex being zero.

The preferences indicated above for Z. A₃, L and E⁻ apply to the compounds of the formula VII. The ligands L can additionally be arenes or heteroarenes (for example benzene, naphthalene, methylbenzene, xylene, cumene, 1,3,5-mesitylene, pyridine, biphenyl, pyrrole, benzimidazole or cyclopentadienyl) and metal salts having a Lewis acid function (for example ZnCl₂, AlCl₃, TiCl₄ and SnCl₄). The solvent ligands can be, for example, alcohols, amines, acid amides, lactams and sulphones.

Complexes of this type are described in the literature mentioned below and the references cited therein:
D. J. Ager, S. A. Laneman, Tetrahedron: Asymmetry, 8, 1997, 3327-3355;
T. Ohkuma, R. Noyori in Comprehensive Asymmetric Catalysis (E. N. Jacobsen, A. Pfaltz, H. Yamamoto, Eds.), Springer, Berlin, 1999, 199-246;
J. M. Brown in Comprehensive Asymmetric Catalysis (E. N. Jacobsen, A. Pfaltz, H. Yamamoto, Eds.), Springer, Berlin, 1999, 122-182;
T. Ohkuma, M. Kitamura, R. Noyori in Catalytic Asymmetric Synthesis, 2nd Edition (I. Ojima, Ed.), Wiley-VCH New York, 2000, 1-110;
N. Zanetti, et al. Organometallics 15, 1996, 860.

The metal complexes of the invention are homogeneous catalysts or catalyst precursors which can be activated under the reaction conditions, which can be used for asymmetric addition reactions onto prochiral, unsaturated, organic compounds.

The metal complexes can, for example, be used for asymmetric hydrogenation (addition of hydrogen) of prochiral compounds having carbon-carbon or carbon-heteroatom double bonds. Such hydrogenations using soluble homogeneous metal complexes are described, for example, in Pure and Appl. Chem., Vol. 68, No. 1, pages 131-138 (1996). Preferred unsaturated compounds to be hydrogenated contain the groups C═C, C═N and/or C═O. According to the invention, metal complexes of ruthenium, rhodium and iridium are preferably used for the hydrogenation.

The invention further provides for the use of the metal complexes of the invention as homogeneous catalysts for preparing chiral organic compounds, preferably for the asymmetric addition of hydrogen onto a carbon-carbon or carbon-heteroatom double bond in prochiral organic compounds.

The invention also provides a process for preparing chiral organic compounds by asymmetric addition of hydrogen onto a carbon-carbon or carbon-heteroatom double bond in prochiral organic compounds in the presence of a catalyst, which is characterized in that the addition reaction is carried out in the presence of catalytic amounts of at least one metal complex according to the invention.

Preferred prochiral, unsaturated compounds to be hydrogenated can contain one or more, identical or different groups C═C, C═N and/or C═O in open-chain or cyclic organic compounds, with the groups C═C, C═N and/or C═O being able to be part of a ring system or being exocyclic groups. The prochiral unsaturated compounds can be alkenes, cycloalkenes, heterocycloalkenes or open-chain or cyclic ketones, α,β-diketones, α- or β-ketocarboxylic acids or their α,β-keto acetals or ketals, esters and amides, ketimines and kethydrazones.

Some examples of unsaturated organic compounds are acatophenone, 4-methoxyacetophenone, 4-trifluoromethylacetophenone, 4-nitroacetophenone, 2-chloroacetophenone, corresponding unsubstituted or N-substituted acetophenonebenzylimines, unsubstituted or substituted benzocyclohexanone or benzocyclopentanone and corresponding imines, imines from the group consisting of unsubstituted or substituted tetrahydroquinoline, tetrahydropyridine and dihydropyrrole, and unsaturated carboxylic acids, esters, amides and salts, for example α- and, if appropriate, β-substituted acrylic acids or crotonic acids. Preferred carboxylic acids are those of the formula

R₁₀₁—CH═C(R₁₀₂)—C(O)OH

and also their salts, esters and amides, where R₁₀₁ is C₁-C₆-alkyl, unsubstituted C₃-C₈-cycloalkyl or C₃-C₈-cyloalkyl substituted by from 1 to 4 C₁-C₆-alkyl, C₁-C₆-alkoxy or C₁-C₆-alkoxy-C₁-C₄-alkoxy groups, or unsubstituted C₆-C₁₀-aryl, preferably phenyl, or C₆-C₁₀-aryl, preferably phenyl, substituted by from 1 to 4 C₁-C₆-alkyl, C₁-C₆-alkoxy or C₁-C₆-alkoxy-C₁-C₄-alkoxy groups, and R₁₀₂ is linear or branched C₁-C₆-alkyl (for example isopropyl) or cyclopentyl, cyclohexyl, phenyl or protected amino (for example acetylamino) which may in each case be unsubstituted or be substituted as defined above.

The process of the invention can be carried out at low or elevated temperatures, for example temperatures of from −20 to 150° C., preferably from −10 to 100° C. and particularly preferably from 10 to 80° C. The optical yields are generally better at relatively low temperature than at higher temperatures.

The process of the invention can be carried out at atmospheric pressure or superatmos-pheric pressure. The pressure can be, for example, from 10⁵ to 2×10⁷ Pa (pascal). Hydrogenations can be carried out at atmospheric pressure or under superatmospheric pressure.

Catalysts are preferably used in amounts of from 0.0001 to 10 mol %, particularly preferably from 0.001 to 10 mol % and in particular from 0.01 to 5 mol %, based on the compound to be hydrogenated.

The preparation of the ligands and catalysts and the hydrogenation can be carried out without solvents or in the presence of an inert solvent, with one solvent or mixtures of solvents being able to be used. Suitable solvents are, for example, aliphatic, cycloaliphatic and aromatic hydrocarbons (pentane, hexane, petroleum ether, cyclohexane, methylcyclohexane, benzene, toluene, xylene), aliphatic halogenated hydrocarbons (methylene chloride, chloroform, dichloroethane and tetrachloroethane), nitriles (acetonitrile, propionitrile, benzonitrile), ethers (diethyl ether, dibutyl ether, t-butyl methyl ether, ethylene glycol dimethyl ether, ethylene glycol diethyl ether, diethylene glycol dimethyl ether, tetrahydrofuran, dioxane, diethylene glycol monomethyl or monoethyl ether), ketones (acetone, methyl isobutyl ketone), carboxylic esters and lactones (ethyl or methyl acetate, valerolactone), N-substituted lactams (N-methylpyrrolidone), carboxamides (dimethylamide, dimethylformamide), acyclic ureas (dimethylimidazoline) and sulphoxides and sulphones (dimethyl sulphoxide, dimethyl sulphone, tetramethylene sulphoxide, tetramethylene sulphone) and alcohols (methanol, ethanol, propanol, butanol, ethylene glycol monomethyl ether, ethylene glycol monoethyl ether, diethylene glycol monomethyl ether) and water. The solvents can be used either alone or as a mixture of at least two solvents.

The reaction can be carried out in the presence of cocatalysts, for example quaternary ammonium halides (tetrabutylammonium iodide) and/or in the presence of protic acids, for example mineral acids (see, for example, U.S. Pat. No. 5,371,256, U.S. Pat. No. 5,446,844 and U.S. Pat. No. 5,583,241 and EP-A-0 691 949). The presence of fluorinated alcohols such as 1,1,1-trifluoroethanol can likewise aid the catalytic reaction.

The metal complexes used as catalysts can be added as separately prepared, isolated compounds or can also be formed in situ prior to the reaction and then be mixed with the substrate to be hydrogenated. It can be advantageous to add additional ligands in the reaction using isolated metal complexes or to use an excess of the ligands in the in-situ preparation. The excess can be, for example, from 1 to 6 mol, preferably from 1 to 2 mol, based on the metal compound used for the preparation.

The process of the invention is generally carried out by initially charging the catalyst and then adding the substrate, if desired reaction auxiliaries and the compound to be added on and subsequently starting the reaction. Gaseous compounds to be added on, for example hydrogen or ammonia, are preferably introduced under pressure. The process can be carried out continuously or batchwise in various types of reactor.

The chiral organic compounds which can be prepared according to the invention are active substances or intermediates for the preparation of such substances, in particular in the field of production of flavours and fragrances, pharmaceuticals and agrochemicals.

The following examples illustrate the invention.

### A) PREPARATION OF SUBSTITUTED FERROCENE-DIPHOSOHINES

Abbreviations: Me is methyl, Et is ethyl, Bu is butyl, Ph is phenyl, Cy is cyclohexyl, Xyl is 3,5-dimethylphen-1-yl; PE is petroleum ether; Et₂O is diethyl ether; nbd=norbornadiene; COD is cyclooctadiene.

### Example A1

### Preparation of (Sₚ)-1-diphenylphosphino-2-dicyclohexylphosphinomethyl-3-methylferrocene (A1)

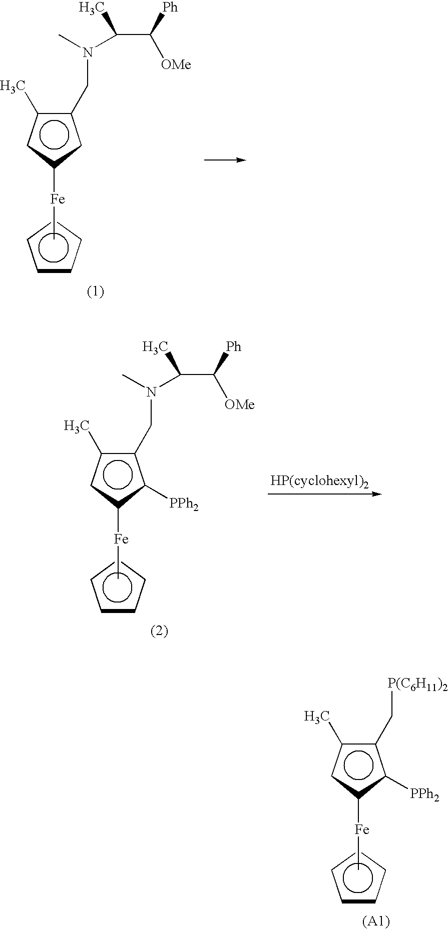

### a) Preparation of Compound (1)

The compound (1) is described in the literature: I. Fleischer, S. Toma, Coll. Czech. Chem. Comm., 69(2), (2004) 330-338.

### b) Preparation of (1R,2S,Sₚ)—N-(1-diphenylphosphino-3-methylferrocen-2-ylmethyl)-N-methyl-1-methoxy-1-phenylprop-2-ylamine (2)

6.6 ml (8.5 mmol) of s-butyllithium (1.3 M in cyclohexane) are added dropwise by means of a syringe to a degassed solution of 2.78 g (7.1 mmol) of compound (1) in 80 ml of absolute diethyl ether. The reaction mixture is stirred at −78° C. for 1 hour and at −30° C. for 40 minutes. 1.92 ml (10.6 mmol) of ClPPh₂ are subsequently added. After 1 hour at −30° C., the mixture is stirred for another 16 hours at room temperature. The reaction is stopped by addition of 1 M aqueous NaOH solution. The aqueous phase is extracted with diethyl ether, and the combined organic phases are then washed with saturated aqueous NaCl solution and dried over MgSO₄. The solvent is removed under reduced pressure and the crude product is purified by means of chromatography [Al₂O₃, PE:Et₂O (10:1)]. This gives the compound (2) as a yellow solid (3 g, 5.2 mmol, 73% of theory).

¹H NMR (400.1 MHz): δ 0.77 (d, 3H), 1.97 (s, 3H), 2.00 (s, 3H), 2.73 (dq, 1H), 2.94 (s, 3H), 3.49 (d, 1H), 3.89 (dd, 1H), 3.70 (d, 1H), 3.75 (d, 1H), 3.85 (s, 5H), 4.22 (d, 1H), 7.09-7.20 (m, 5H), 7.20-7.26 (m, 3H), 7.26-7.33 (m, 2H), 7.34-7.43 (m, 3H), 7.54-7.64 (m, 2H). ³¹P-NMR (162.0 MHz): δ −23.0 (s).

### c) Preparation of the Title Compound A1

0.43 ml (2.09 mmol) of HPCy₂ is added dropwise by means of a syringe to a degassed solution of 1 g (1.74 mmol) of compound (2) in 12 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography (Al₂O₃, PE:Et₂O:Et₃N (40:1:0.4)). This gives the title compound A1 as a yellow solid (0.85 g, 14.3 mmol, 82% of theory).

¹H NMR (400.1 MHz): δ. 000.6 (m, 1H), 0.79-1.33 (m, 12H), 1.35-1.89 (m, 11H), 2.12 (s, 3H), 2.65 (dd, 1H), 3.07 (dt, 1H), 3.72 (s, 5H), 3.80 (d, 1H), 4.26 (d, 1H), 7.12-7.23 (m, 5H), 7.33-7.40 (m, 3H), 7.55-7.63 (m, 2H). ³¹P-NMR (162.0 MHz): δ −22.6 (d), 3.5 (d).

### Example A2

### Preparation of (Sₚ)-1-diphenylphosphino-2-di-t-butylphosphinomethyl-3-methylferrocene (A2)

0.48 ml (2.61 mmol) of HP(t-Bu)₂ is added dropwise by means of a syringe to a degassed solution of 1 g (1.74 mmol) of compound (2) in 12 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography [Al₂O₃, PE:Et₂O:Et₃N (40:1:0.1)]. This gives the desired product as a yellow solid (0.71 g, 13.1 mmol, 75% of theory).

¹H NMR (400.1 MHz): δ 0.96 (d, 9H), 1.06 (d, 9H), 2.22 (s, 3H), 2.88 (d, 1H), 3.24 (dt, 1H), 3.69 (s, 5H), 3.90 (d, 1H), 4.24 (d, 1H), 7.15-7.21 (m, 3H), 7.24-7.31 (m, 2H), 7.33-7.39 (m, 3H), 7.60-7.68 (m, 2H). ³¹P-NMR (162.0 MHz): δ −23.7 (d), 30.2 (d).

### Example A3

### Preparation of (Sₚ)-1-diphenylphosphino-2-bis(3,5-dimethylphenyl)phosphinomethyl-3-methylferrocene (A3)

2.89 ml of a solution of HP[3,5-(CH₃)₂C₆H₃]₂ (0.7 g, 2.90 mmol) in toluene (24.3%) are added dropwise by means of a syringe to a degassed solution of 1.11 g (1.93 mmol) of compound (2) in 13 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography [Al₂O₃, PE:Et₂O (5:1)]. This gives the title compound as a yellow solid (0.77 g, 12.1 mmol, 63% of theory).

¹H NMR (400.1 MHz): δ 1.65 (s, 3H), 2.21 (s, 6H), 2.27 (s, 6H), 3.29 (dd, 1H), 3.68 (dt, 1H), 3.75 (s, 5H), 3.77 (d, 1H), 4.17 (d, 1H), 6.74 (s, 1H), 6.92 (s, 1H), 6.97 (d, 2H), 6.99 (d, 2H), 7.07-7.14 (m, 2H), 7.14-7.20 (m, 3H), 7.33-7.42 (m, 3H), 7.55-7.66 (m, 2H). ³¹P-NMR (162.0 MHz): δ −22.2 (d), −11.5 (d).

### Example A4

### Preparation of (Sₚ)-1-diphenylphosphino-2-dicyclohexylphosphinomethyl-3-phenylferrocene

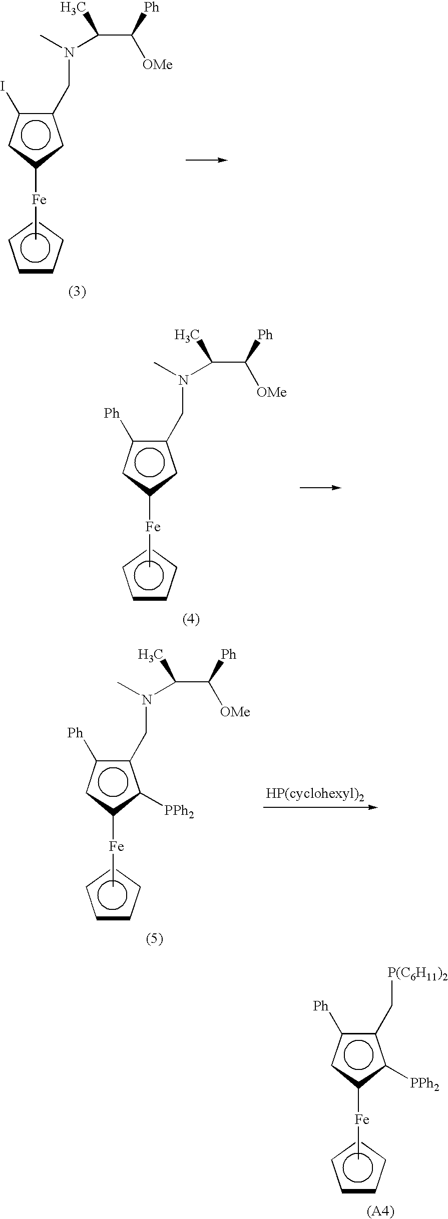

### a) Preparation of Compound (3)

The compound (3) is described in the literature: W. Weissensteiner et al., J. Org. Chem., 66 (2001) 8912-9.

### b) Preparation of Compound (4)

0.66 g (0.5 mmol) of Pd(PPh₃)₄ is added to a degassed mixture of 6.65 g (13.2 mmol) of compound (3) in 125 ml of toluene, 3.22 g (26.4 mmol) of phenylboronic acid in 14 ml of ethanol and 27.7 ml of a 2 M aqueous Na₂CO₃ solution at room temperature. The reaction mixture is degassed once more and refluxed for 16 hours. The mixture is allowed to cool and the organic phase is separated off and then washed with water and saturated aqueous NaCl solution and dried over MgSO₄. The solvent is removed under reduced pressure and the crude product is purified by means of chromatography [Al₂O₃, PE:Et₂O:Et₃N (30:3:1)]. This gives the compound (4) as a yellow oil (3.0 g, 6.2 mmol, 50% of theory).

¹H NMR (400.1 MHz): δ 1.11 (d, 3H), 2.20 (s, 3H), 3.09 (dq, 1H), 3.15 (s, 3H), 3.44 (s, 2H), 3.99 (s, 5H), 4.07 (d, 1H), 4.18 (t, 1H), 4.20-4.22 (m, 1H), 4.41 (dd, 1H), 7.01-7.10 (m, 3H), 7.10-7.21 (m, 5H), 7.38-7.45 (m, 2H).

### c) Preparation of Compound (5)

3.8 ml (4.9 mmol) of s-butyllithium (1.3 M in cyclohexane) are added dropwise by means of a syringe to a degassed solution of 1.7 g (3.8 mmol) of compound (4) in 15 ml of absolute diethyl ether at 0° C. The reaction mixture is stirred at 0° C. for 2 hours. 1.39 g (6.29 mmol) of ClPPh₂ are added thereto, and the mixture is stirred for another hour at 0° C. and subsequently for 16 hours at room temperature. Water is added and the aqueous phase is extracted with dichloromethane. The combined organic phases are washed with saturated aqueous NaCl solution, dried over MgSO₄ and freed of the solvent under reduced pressure. The crude product is purified by means of chromatography [Al₂O₃, PE:Et₂O:Et₃N (30:1:1)]. This gives the desired product as a yellow foam (1.62 g, 2.54 mmol, 68% of theory).

¹H NMR (400.1 MHz): δ 0.66 (d, 3H), 1.79 (s, 3H), 2.68 (dq, 1H), 2.85 (s, 3H), 3.68-3.71 (m, 1H), 3.71 (d, 1H), 3.88 (s, 5H), 4.02 (d, 1H), 4.05 (dd, 1H), 4.58 (d, 1H), 7.00-7.05 (m, 2H), 7.11-7.20 (m, 4H), 7.21-7.29 (m, 5H), 7.29-7.36 (m, 2H), 7.36-7.42 (m, 3H), 7.59-7.66 (m, 4H). ³¹P-NMR (162.0 MHz): δ −21.0 (s).

### d) Preparation of the Title Compound (A4)

0.43 ml (2.12 mmol) of HPCy₂ is added dropwise by means of a syringe to a degassed solution of 0.9 g (1.41 mmol) of compound (5) in 50 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography [Al₂O₃, PE:Et₂O (50:1)]. This gives the desired product as a yellow solid (0.68 g, 1.04 mmol, 74% of theory).

¹H NMR (400.1 MHz): δ. 0.639 (m, 22H), 2.98 (dd, 1H), 3.06 (d, 1H), 3.80 (s, 5H), 4.08 (d, 1H), 4.53 (d, 1H), 7.14-7.25 (m, 5H), 7.27-7.31 (m, 1H), 7.33-7.43 (m, 5H), 7.61-7.69 (m, 4H). ³¹P-NMR (162.0 MHz): δ −22.6 (d), 6.9 (d).

### Example A5

### Preparation of (Sₚ)-1-diphenylphosphino-2-di-t-butylphosphinomethyl-3-phenylferrocene (A5)

5.2 ml (2.82 mmol) of a solution of HP(t-Bu)₂ in acetic acid (10%) are added dropwise by means of a syringe to a degassed solution of 1.2 g (1.88 mmol) of compound (5) in 50 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography [Al₂O₃, PE:Et₂O (50:1)]. This gives the title compound (A5) as a yellow solid (0.86 g, 1.42 mmol, 74% of theory).

¹H NMR (400.1 MHz): δ 0.54 (d, 9H), 1.11 (d, 9H), 3.14 (s, 2H), 3.77 (s, 5H), 4.15 (d, 1H), 4.48 (d, 1H), 7.15-7.24 (m, 3H), 7.27-7.34 (m, 3H), 7.34-7.42 (m, 5H), 7.57-7.63 (m, 2H), 7.64-7.72 (m, 2H). ³¹P-NMR (162.0 MHz): δ −23.5 (d), 36.9 (d).

### Example A6

### Preparation of (Sₚ)-1-diphenylphosphino-2-bis(3,5-dimethylphenyl)phosphinomethyl-3-phenylferrocene (A6)

2.48 ml of a solution of HP[3,5-(CH₃)₂C₆H₃]₂ (0.6 g, 2.49 mmol) in toluene (24.3%) are added dropwise by means of a syringe to a degassed solution of 0.86 g (1.71 mmol) of compound (5) in 13 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography [Al₂O₃, PE:Et₂O (10:1)]. This gives the title compound (A6) as a yellow solid (0.7 g, 1.0 mmol, 59% of theory).

¹H NMR (400.1 MHz): δ 2.05 (s, 6H), 2.20 (s, 6H), 3.58 (dd, 1H), 3.75 (dt, 1H), 3.81 (s, 5H), 4.02 (d, 1H), 4.46 (d, 1H), 6.51 (d, 2H), 6.72 (s, 1H), 6.77 (s, 1H), 6.88 (d, 2H), 7.12-7.25 (m, 8H), 7.35-7.43 (m, 5H), 7.60-7.69 (m, 2H). ³¹P-NMR (162.0 MHz): δ −22.6 (d), −7.7 (d).

### Example A7

### Preparation of (Sₚ)-1-diphenylphosphino-2-dicyclohexylphosphinomethyl-3-(3,5-dimethylphen-1-yl)ferrocene(A7)

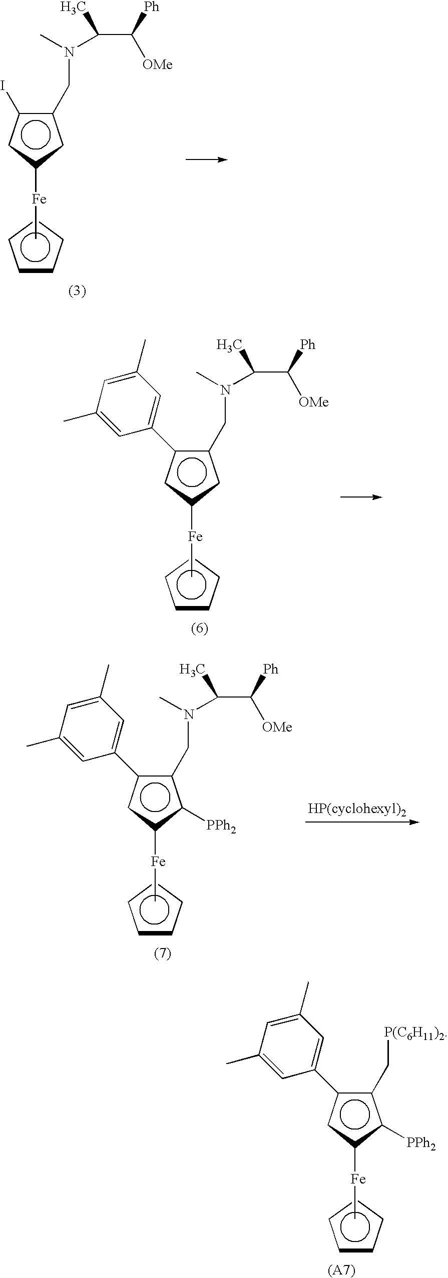

### a) Preparation of Compound (6)

0.12 g (0.1 mmol) of Pd(PPh₃)₄ is added to a degassed mixture of 1.0 g (2 mmol) of compound 3 in 20 ml of toluene, 0.6 g (4 mmol) of (3,5-dimethylphen-1-yl)boronic acid in 3 ml of ethanol and 4.2 ml of a 2M aqueous Na₂CO₃ solution at room temperature. The reaction mixture is degassed once more and refluxed for 16 hours. The mixture is allowed to cool and the organic phase is separated off and washed with water and saturated aqueous NaCl solution and dried over MgSO₄. The solvent is removed under reduced pressure and the crude product is purified by means of chromatography [Al₂O₃, PE:Et₂O:Et₃N (20:1:0.2)]. This gives compound (6) as a yellow oil (0.8 g, 1.6 mmol, 80% of theory).

¹H NMR (400.1 MHz): δ 1.14 (d, 3H), 2.21 (s, 3H), 2.23 (s, 6H), 3.15 (dq, 1H), 3.16 (s, 3H), 3.40, 3.44 (m, 2H), 3.99 (s, 5H), 4.07 (d, 1H), 4.17 (t, 1H), 4.19-4.23 (m, 1H), 4.39 (dd, 1H), 6.79 (s, 1H), 7.00-7.05 (m, 2H, Ph), 7.07 (s, 2H), 7.05-7.10 (m, 1H), 7.10-7.17 (m, 2H).

### b) Preparation of Compound (7)

5.8 ml (7.6 mmol) of s-butyllithium (1.3 M in cyclohexane) are added dropwise by means of a syringe to a degassed solution of 2.8 g (5.8 mmol) of compound (6) in 35 ml of absolute diethyl ether at 0° C. The reaction mixture is stirred at 0° C. for 2 hours. 1.93 g (8.7 mmol) of ClPPh₂ are added thereto, and the mixture is then stirred for another hour at 0° C. and subsequently for 16 hours at room temperature. Water is added and the aqueous phase is extracted with dichloromethane. The combined organic phases are washed with saturated aqueous NaCl solution, dried over MgSO₄ and freed of the solvent under reduced pressure. The crude product is purified by means of chromatography [Al₂O₃, PE:Et₂O:Et₃N (30:1:0.3)]. This gives compound (7) as a yellow foam (3.25 g, 4.88 mmol, 84% of theory).

¹H NMR (400.1 MHz): δ 0.67 (d, 3H), 1.83 (s, 3H), 2.35 (s, 6H), 2.66 (dq, 1H), 2.88 (s, 3H), 3.71 (d, 1H), 3.75 (d, 1H), 3.86 (s, 5H), 4.00 (d, 1H), 4.06 (dd, 1H), 4.56 (d, 1H), 6.90 (s, 1H), 6.98-7.03 (m, 2H), 7.12-7.19 (m, 4H), 7.20-7.29 (m, 6H), 7.36-7.41 (m, 3H), 7.59-7.66 (m, 2H). ³¹P-NMR (162.0 MHz): δ −21.1 (s).

### c) Preparation of Compound (A7)

0.48 ml (2.39 mmol) of HP(CH₁₁)₂ is added dropwise by means of a syringe to a degassed solution of 1.06 g (1.59 mmol) of compound (7) in 50 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography [Al₂O₃, PE:Et₂O (50:1)]. This gives the title compound as a yellow foam (0.62 g, 1.04 mmol, 57% of theory).

¹H NMR (400.1 MHz): δ. 0.664 (m, 22H), 2.43 (s, 6H), 3.04 (dd, 1H), 3.10 (dd, 1H), 3.86 (s, 5H), 4.11 (d, 1H), 4.56 (d, 1H), 6.98 (s, 1H), 7.21-7.29 (m, 5H), 7.31 (s, 2H), 7.40-7.49 (m, 3H), 7.66-7.76 (m, 2H). ³¹P-NMR (162.0 MHz): δ −22.5 (d), 7.3 (d).

### Example A8

### Preparation of (Sₚ)-1-diphenylphosphino-2-di-t-butylphosphinomethyl-3-(3,5-dimethylphen-1-yl)ferrocene (A8)

3.3 ml (1.80 mmol) of a solution of HP(t-Bu)₂ in acetic acid (10%) are added dropwise by means of a syringe to a degassed solution of 0.75 g (1.12 mmol) of compound (7) in 10 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography [Al₂O₃, PE:Et₂O (50:1)]. This gives the title compound as an orange foam (0.6 g, 0.95 mmol, 85% of theory).

¹H NMR (400.1 MHz): δ 0.56 (d, 9H), 1.08 (d, 9H), 2.36 (s, 6H), 3.08-3.1.9 (m, 2H), 3.76 (s, 5H), 4.12 (d, 1H), 4.46 (dd, 1H), 6.91 (s, 1H), 7.15-7.24 (m, 5H), 7.27-7.33 (m, 2H), 7.33-7.41 (m, 3H), 7.64-7.72 (m, 2H). ³¹P-NMR (162.0 MHz): δ −23.4 (d), 36.2 (d).

### Example A9

### Preparation of (Sₚ)-1-diphenylphosphino-2-bis(3,5-dimethylphosphino)methyl-3-(3,5-dimethylphen-1-yl)ferrocene (A9)

0.2 ml of a solution of HP[3,5-(CH₃)₂C₈H₃]₂ (54 mg, 0.22 mmol) in toluene (24.3%) is added dropwise by means of a syringe to a degassed solution of 0.1 g (0.15 mmol) of compound (7) in 5 ml of acetic acid. The reaction mixture is degassed once more and stirred at 100° C. for 16 hours. The acetic acid is subsequently removed under reduced pressure. The residue is dissolved in CH₂Cl₂ and washed with saturated aqueous NaHCO₃ solution, water and saturated aqueous NaCl solution. The organic phase is dried over MgSO₄ and the solvent is removed under reduced pressure. The crude product is purified by means of chromatography [Al₂O₃, PE:Et₂O (30:1)]. This gives the title compound as an orange foam (50 mg, 0.07 mmol, 46%).

¹H NMR (400.1 MHz): δ 2.06 (s, 6H), 2.19 (s, 6H), 2.28 (s, 6H), 3.61 (dd, 1H), 3.72 (br d, 1H), 3.80 (s, 5H), 4.00 (d, 1H), 4.43 (d, 1H), 6.54 (d, 2H), 6.73 (s, 1H), 6.76 (s, 1H), 6.83 (s, 1H), 6.88 (d, 2H), 7.00 (s, 2H), 7.12-7.21 (m, 5H), 7.35-7.40 (m, 3H), 7.59-7.69 (m, 2H). ³¹P-NMR (162.0 MHz): δ −22.4 (d), −7.4 (d).

### B) PREPARATION OF METAL COMPLEXES

### Example B1

5.1 mg (0.0136 mmol) of [Rh(nbd)₂]BF₄ and 10.4 mg (0.0163 mmol) of ligand A1 from Example A6 are weighed into a Schlenk vessel provided with a magnetic stirrer and the air is displaced by means of vacuum and argon. After addition of 0.8 ml of degassed methanol with stirring, an orange solution of the metal complex (catalyst solution) is obtained. A uniform, C2-symmetric complex is formed.

### C) USE EXAMPLES

### Example C1

### Hydrogenation of Unsaturated Compounds

The method of carrying out the hydrogenations and the determination of the optical yields ee is described in general terms by W. Weissensteiner et al. in Organometallics 21 (2002), pages 1766-1774. The catalysts are prepared in “in situ” by mixing ligand and metal complex as catalyst precursor (=[Rh(norbornadiene)₂]BF₄ unless indicated otherwise) in the solvent. Unless indicated otherwise, the substrate concentration is 0.25 mol/l, and the molar ratio of substrate to metal=200 and the molar ratio of ligand to metal=1.05.

### Hydrogenations:

Reaction conditions for the substrates MAC and DMI:

Molar ratio of substrate to metal=200; catalyst precursor=[Rh(norbornadiene)₂]BF₄; solvent=MeOH; hydrogen pressure=1 bar; temperature=25° C.; reaction time 1 hour.

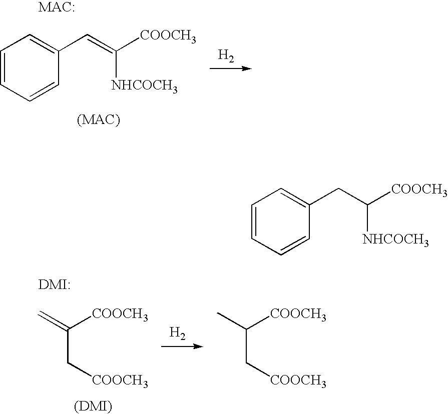

Reaction conditions for the substrate MEA:

Molar ratio of substrate to metal=100; catalyst precursor=[Ir(COD)Cl]₂; solvent=toluene; additions: 2 equivalents of tetrabutylammonium iodide per equivalent of Ir and 0.03 ml of trifluoroacetic acid per 10 ml of toluene; hydrogen pressure=80 bar; temperature=25° C.; reaction time=16 hours.

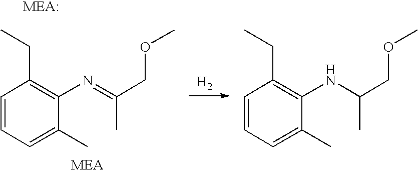

The results of the hydrogenation are reported in Table 1 below. “ee” is the enantiomeric excess. The configuration is indicated in brackets. It can be seen from the results with the comparative ligand and substituted ligands in Table 1 that the substitution can surprisingly influence and invert the configuration. Furthermore, the increase in the optical yields on introduction of substituents can be seen.

The structures of the comparative ligands C1, C2 and C3 are given below:

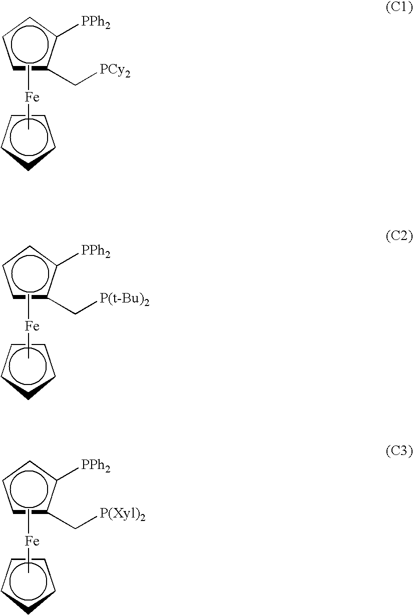

TABLE 1

| Ligand | Substrate | Metal complex | Conversion (%) | ee (%) | |
|---|---|---|---|---|---|
| C1 | DMI | [Rh(nbd)₂]BF₄ | 100 | 97.7 | (R) |
| A1 | DMI | [Rh(nbd)₂]BF₄ | 100 | 99 | (S) |
| C2 | DMI | [Rh(nbd)₂]BF₄ | 55 | 18 | (S) |
| A2 | DMI | [Rh(nbd)₂]BF₄ | 49 | 42 | (R) |
| A5 | DMI | [Rh(nbd)₂]BF₄ | 43 | 25 | (S) |
| C3 | MAC | [Rh(nbd)₂]BF₄ | 100 | 49 | (R) |
| A3 | MAC | [Rh(nbd)₂]BF₄ | 100 | 67 | (S) |
| A6 | MAC | [Rh(nbd)₂]BF₄ | 100 | 83 | (S) |
| A9 | MAC | [Rh(nbd)₂]BF₄ | 100 | 84 | (S) |
| C3 | MEA | [Ir(COD)Cl₂] | 100 | 72 | (R) |
| A3 | MEA | [Ir(COD)Cl₂] | 100 | 76.8 | (S) |
| A6 | MEA | [Ir(COD)Cl₂] | 100 | 78.4 | (S) |
| A9 | MEA | [Ir(COD)Cl₂] | 100 | 80.6 | (S) |

### Example C2

### Preparation of N-(2′-methyl-6′-ethylphen-1′-yl)-1-methoxymethylethylamine

1.65 mg of [Ir(cyclooctadiene)Cl]₂, 2.8 mg of ligand, 70 mg of tetrabutylammonium iodide and 10 ml of acetic acid are added to 105 g of imine (1) in an autoclave. The conditions correspond to a ratio of substrate to iridium of 100 000. The autoclave is closed and flushed with argon. The argon is then replaced by flushing with hydrogen and the autoclave is pressurized with hydrogen (80 bar). The hydrogenation is started by switching on the stirrer. After the hydrogenation, the conversion and the optical yield (ee) are determined by means of HPLC [Chiracel OD; eluent hexane/i-propanol (99.6:0.4), flow: 1 ml/minute]. The results are reported in Table 2 below, including the configuration for the optical yield (R or S configuration).

TABLE 2

| Ligand | Time (h) | Conversion (%) | TOF (50%; 1/h) | ee* (%) |
|---|---|---|---|---|
| C3 | 19 | 100 | 116 000 | 68.2 (R) |
| A3 | 2.5 | 100 | 131 000 | 72.2 (R) |
| A6 | 20 | 100 | 190 000 | 72.7 (R) |
| A9 | 20 | 100 | 234 000 | 74.7 (R) |

*The product having the inverse configuration is obtained by use of the ligands in their other enantiomeric form.

1. Compounds of the formula I in the form of racemates, mixtures of stereoisomers or optically pure stereoisomers 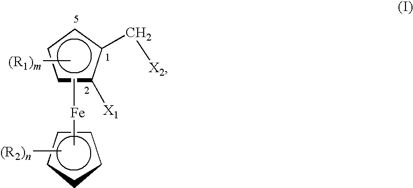
where
X₁ and X₂ are each, independently of one another, a secondary phosphino group;
R₁ is a halogen atom or a substituent bound via a C atom, N atom, S atom, Si atom, a P(O) group or a P(S) group to the cyclopentadienyl ring, with the radicals R₁ in the case of m>1 being identical or different;
R₂ is C₁-C₄-alkyl or phenyl;
m is from 1 to 3 and
n is O or from 1 to 5.

2. Compounds according to claim 1, characterized in that the secondary phosphino groups X₁ and X₂ contain two identical or two different hydrocarbon radicals and in that the secondary phosphino groups X₁ and X₂ are identical or different.

3. Compounds according to claim 1, characterized in that X₁ and X₂ are identical or different noncyclic sec-phosphino groups selected from the group consisting of —P(C₁-C₆-alkyl)₂, —P(C₅-C₈Cycloalkyl), —P(C₇-C₁₂-bicycloalkyl), —P(o-furyl), —P(C₆H₅), —P[2-(C₁-C₆-alkyl)C₆H₄]₂, —P[3-(C₁-C₆-alkyl)C₆H₄]₂, —P[4-(C₁-C₆-alkyl)C₆H₄]₂, —P[2-(C₁-C₆-alkoxy)C₆H₄]₂, —P[3-(C₁-C₆-alkoxy)C₆H₄]₂, —P[4-(C₁-C₆-alkoxy)C₆H₄]₂, —P[2-(trifluoromethyl)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis(C₁-C₆-alkyl)₂C₆H₃]₂, —P[3,5-bis(C₁-C₆-alkoxy)₂C₆H₃]₂, —P[3,4,5-tris(C₁-C₆-alkoxy)₂C₆H₃]₂ and —P[3,5-bis(C₁-C₆-alkyl)₂-4-(C₁-C₆-alkoxy)C₆H₂]₂, or cyclic phosphine selected from the group consisting of 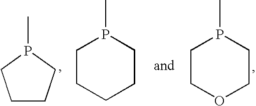
which are unsubstituted or substituted by one or more substituents selected from among C₁-C₄-alkyl, C₁-C₄-alkoxy, C₁-C₄-alkoxy-C₁-C₂-alkyl, phenyl, benzyl, benzyloxy, C₁-C₄-alkylidenedioxyl and unsubstituted or phenyl-substituted methylenedioxyl.

4. Compounds according to claim 1, characterized in that X₁ and X₂ are each —P(CH₃)₂, —P(i-C₃H₇)₂, —P(n-C₄H₉)₂, —P(i-C₄H₉), —P(CH₁₁)₂, —P(norbornyl)₂, —P(o-furyl)₂, —P(C₆H₅)₂, P[2-(methyl)C₆H₄]₂, P[3-(methyl)C₆H₄]₂, —P[4-(methyl)C₆H₄]2, —P[2-(methoxy)C₆H₄]₂, —P[3-(methoxy)C₆H₄]₂, —P[4-(methoxy)C₆H₄]₂, —P[3-trifluoromethyl)C₆H₄]₂, —P[4-(trifluoromethyl)C₆H₄]₂, —P[3,5-bis(trifluoromethyl)C₆H₃]₂, —P[3,5-bis(methyl)C₆H₃]₂, —P[3,5-bis(methoxy)C₆H₃]₂, —P[3,4,5-tri(methoxy)C₆H₂]₂, —P[3,5-bis(methyl)₂-4-(methoxy)C₆H₂]₂ or a group having one of the formulae 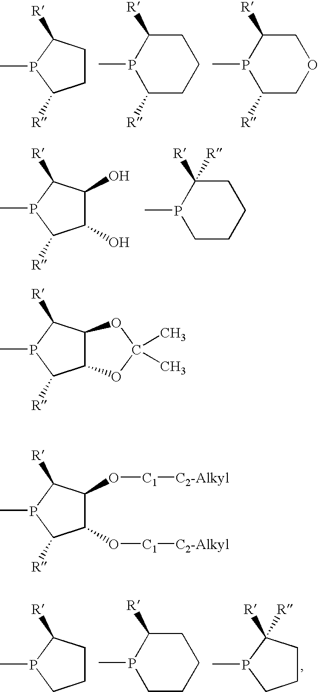
where
R′ is methyl, ethyl, methoxy, ethoxy, phenoxy, benzyloxy, methoxymethyl, ethoxymethyl or benzyloxymethyl and R″ has one of the meanings of R′.

5. Compounds according to claim 1, characterized in that n in formula I is 0.

6. Compounds according to claim 1, characterized in that a substituent R₁ is bound in the 5 position and the substituent is a bulky substituent.

7. Compounds according to claim 1, characterized in that the substituents R₁ are selected from among C₁-C₄-alkyl, substituted or unsubstituted phenyl, tri(C₁-C₄-alkyl)Si, triphenylsilyl, halogen, —SR₀₆, —CH₂OH, —CHR₀₆OH, —CR₀₆R′₀₆OH, —CH₂O—R₀₆, —CH(O), —CO₂H, —CO₂R₀₆, where R₀₆ is a hydrocarbon radical having from 1 to 10 carbon atoms and R′₀₆O independently has one of the meanings of R′₀₆, and —P(O)(R₀₃)₂, where R₀₃ is hydrogen, C₁-C₈-alkyl, C₅-C₆-cycloalkyl, phenyl or benzyl.

8. Compounds according to claim 1, characterized in that the compounds of the formula I correspond to racemates, mixtures of stereoisomers or optically pure stereoisomers of the formula Ia 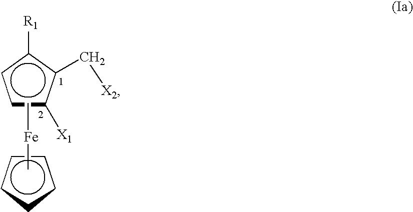
where
X₁ and X₂ are each, independently of one another, a secondary phosphino group;
R₁ is a halogen atom or a substituent bound via a carbon atom or Si atom to the cyclopentadienyl ring.

9. Compounds according to claim 8, characterized in that R₁ is substituted or unsubstituted linear or branched C₁-C₁₂-alkyl, substituted or unsubstituted C₃-C₁₂-cycloalkyl, substituted or unsubstituted C₃-C₈-cycloalkyl-C₁-C₄-alkyl, substituted or unsubstituted C₆-C₁₈-aryl, substituted or unsubstituted C₇-C₁₈-aralkyl, tri(C₁-C₄-alkyl)Si—, triphenylsilyl or F, Cl and Br.

10. Complexes of metals selected from the group of transition metals of the Periodic Table of the Elements, preferably from the group Cu, Ag, Au, Ni, Co, Rh, Pd, Ir, Ru and Pt, with compounds of the formula I as ligands.

11. Metal complexes according to claim 10 which correspond to the formulae III and IV,
A₃MeL_{r,} (III)
(A₃MeLᵣ)^{(z+)}(E⁻)_{z,} (IV)
where
A₃ is one of the compounds of the formula I,
L represents identical or different monodentate, anionic or nonionic ligands, or L represents identical or different bidentate, anionic or nonionic ligands;
r is 2, 3 or 4 when L is a monodentate ligand or n is 1 or 2 when L is a bidentate ligand;
z is 1, 2 or 3;
Me is a metal selected from the group consisting of Rh, Ir and Ru; with the metal having the oxidation state 0, 1, 2, 3 or 4;
E⁻ is the anion of an oxo acid or complex acid; and
the anionic ligands balance the charge of the oxidation state 1, 2, 3 or 4 of the metal.

12. Metal complexes according to claim 10 which correspond to the formula VII
[RuₐH_{b}Z_{c}(A₃)_{d}Lₐ]ᵣ(E^{k})_{g}(S)_{h,} (VII)
where
Z is Cl, Br or I; A₃ is a compound of the formula I; L represents identical or different ligands; E⁻ is the anion of an oxo acid, mineral acid or complex acid; S is a solvent capable of coordination as ligand; and a is from 1 to 3, b is from 0 to 4, c is from 0 to 6, d is from 1 to 3, e is from 0 to 4, f is from 1 to 3, g is from 1 to 4, h is from 0 to 6 and k is from 1 to 4, with the total charge on the complex being zero.

13. Process for preparing chiral organic compounds by asymmetric addition of hydrogen onto a carbon-carbon or carbon-heteroatom double bond in prochiral organic compounds in the presence of a catalyst, characterized in that the addition reaction is carried out in the presence of catalytic amounts of at least one metal complex according to claim 10.

14. Use of the metal complexes according to claim 10 as homogeneous catalysts for the preparation of chiral organic compounds, preferably for the asymmetric addition of hydrogen onto a carbon-carbon or carbon-heteroatom double bond in prochiral organic compounds.
